(19) United States
(12) Patent Application Publication
(10) Pub. No.: US 2017/0148174 A1
(43) Pub. Date: May 25, 2017

(54) OBJECT TRACKING METHOD AND OBJECT TRACKING APPARATUS FOR PERFORMING THE METHOD

(71) Applicant: Electronics and Telecommunications Research Institute, Daejeon (KR)

(72) Inventors: Kwang Yong KIM, Daejeon (KR); Yoo Kyung KIM, Daejeon (KR); Gi Mun UM, Daejeon (KR); Alex LEE, Daejeon (KR); Kee Seong CHO, Daejeon (KR); Gyeong June HAHM, Daejeon (KR)

(21) Appl. No.: 15/186,634

(22) Filed: Jun. 20, 2016

(30) Foreign Application Priority Data
Nov. 20, 2015 (KR) 10-2015-0163420

(51) Int. Cl. G06T 7/20; G06T 7/00; G06K 9/62; G01C 3/08; G06T 7/60; G06K 9/52; H04N 5/247; G06K 9/00; G06K 9/46

(52) U.S. Cl. CPC G06T 7/2033; G06K 9/00335; G06T 7/0042; G06K 9/6267; G06K 9/4671; G06T 7/60; G06K 9/52; H04N 5/247; G01C 3/08

(57) ABSTRACT

Disclosed are an object tracking method and an object tracking apparatus performing the object tracking method. The object tracking method may include extracting locations of objects in an object search area using a global camera, identifying an interest object selected by a user from the objects, and determining an error in tracking the identified interest object and correcting the determined error.

### CROSS-REFERENCE TO RELATED APPLICATION(S)

This application claims the priority benefit of Korean Patent Application No. 10-2015-0163420 filed on Nov. 20, 2015, in the Korean Intellectual Property Office, the disclosure of which is incorporated herein by reference for all purposes.

### BACKGROUND

1. Field

One or more example embodiments relate to an object tracking method and an object tracking apparatus for performing the object tracking method, and more particularly, to a method and apparatus for tracking a location of an interest object, or an object of interest (OOI), that moves in a space using an imaging device, and for detecting an error associated with the tracked location of the interest object and correcting the detected error.

2. Description of Related Art

An object tracking method, which is used to track an object using a camera, may track an interest object, or an object of interest (OOI), that moves in a space, and also process image information associated with the tracked interest object. Thus, the object tracking method is used in various fields, for example, a sports and a security service.

The object tracking method may track an object selected by a user, or track an object using a plurality of cameras of which a location is controlled based on a movement of the object. Here, the object tracking method may identify the object through a feature point-based tracking method by applying, for example, a color distribution and an edge component, using image information associated with the object obtained through the plurality of cameras, or through an optical flow-based tracking method using a flow of the movement and a directional component.

However, such an object tracking method may not accurately identify an object when the object overlaps an obstacle in image information or the object disappears from a space and then reappears in the space. For example, the object tracking method may not track the object or may track another object that is not the object previously tracked, when information of the object extracted through the feature point-based tracking method or the optical flow-based tracking method changes due to the overlap between the object and the obstacle.

That is, the object tracking method may track another object or generate a drift state in which a camera is not able to track an interest object, when an error occurs in tracking the interest object due to an exceptional situation, for example, an occlusion among objects or a disappearance and reappearance of the interest object from and in a visual field of the camera.

Thus, there is a desire for a method of minimizing an error in tracking an object in consideration of an exceptional situation that may occur when tracking the object.

### SUMMARY

An aspect provides an object tracking method and apparatus that may track locations of objects using a global camera provided for capturing an overall object search area, and identify an interest object corresponding to a tracked location.

Another aspect also provides an object tracking method and apparatus that may determine a tracking error associated with an interest object using identification information of an identified interest object, and correct a location of the interest object based on the determined tracking error.

According to an aspect, there is provided an object tracking method including extracting a location of an interest object, or an object of interest (OOI), from a global image obtained by capturing an object search area including the interest object using a global camera, capturing the interest object using a local camera adjacent to the location of the interest object, identifying a location of the interest object from a local image obtained by the local camera, and determining a tracking error associated with the interest object by analyzing the location of the interest object extracted from the global image and the location of the interest object identified from the local image.

The extracting of the location of the interest object from the global image may include extracting the location of the interest object from the global image based on a width of the object search area and a height from a ground of the object search area to a location at which the global camera is installed.

The capturing of the interest object may include capturing the interest object using a plurality of local cameras of which locations for capturing the object search area are controlled based on the location of the interest object extracted from the global image.

The identifying of the location of the interest object may include identifying the interest object included in the local image by analyzing the local image obtained by the plurality of local cameras from multiple angles at the controlled locations.

The determining of the tracking error associated with the interest object may include determining the tracking error by analyzing a case in which the interest object is located adjacent to a fixed object in the object search area.

The determining of the tracking error associated with the interest object may include determining the tracking error by analyzing whether a location of the interest object is included in an area of the fixed object in the object search area.

The determining of the tracking error associated with the interest object may include determining the tracking error by analyzing a case in which the interest object is located adjacent to a moving object in the object search area.

The determining of the tracking error associated with the interest object may include determining the tracking error based on a distance between a central location of the interest object and a central location of a moving object having a largest overlapping area with the interest object among other objects in the object search area.

The determining of the tracking error associated with the interest object may include determining the tracking error based on a size of an area of the interest object occluded by the moving object and a size of an area of the interest object.

The determining of the tracking error associated with the interest object may include determining the tracking error by analyzing a new object entering the object search area.

According to another aspect, there is provided an object tracking apparatus including a location extractor configured to extract a location of an interest object from a global image obtained by capturing an object search area including the interest object using a global camera, an interest object identifier configured to capture the interest object using a local camera adjacent to the location of the interest object and identify a location of the interest object from a local image obtained by the local camera, a tracking error determiner configured to determine a tracking error associated with the interest object by comparing the location of the interest object extracted from the global image and the location of the interest object identified from the local image, and a tracking location corrector configured to correct a tracking location of the interest object based on a result of determining the tracking error.

The tracking error determiner may determine the tracking error associated with the interest object by analyzing a case in which the interest object is located adjacent to a fixed object in the object search area.

The tracking error determiner may determine the tracking error associated with the interest object by analyzing whether a location of the interest object is included in an area of the fixed object in the object search area.

The tracking error determiner may determine the tracking error associated with the interest object by analyzing a case in which the interest object is located adjacent to a moving object in the object search area.

The tracking error determiner may determine the tracking error associated with the interest object based on a distance between a central location of the interest object and a central location of a moving object having a largest overlapping area with the interest object among other objects in the object search area.

The tracking error determiner may determine the tracking error associated with the interest object based on a size of an area of the interest object occluded by the moving object and a size of an area of the interest object.

The tracking error determiner may determine the tracking error associated with the interest object by analyzing a new object entering the object search area.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of tracking an interest object, or an object of interest (OOI), according to an example embodiment;

FIG. 2 is a diagram illustrating an example of an object tracking apparatus according to an example embodiment;

FIG. 3 is a diagram illustrating an example of determining a tracking error associated with an interest object according to an example embodiment;

FIG. 4 is a diagram illustrating another example of determining a tracking error associated with an interest object according to an example embodiment;

FIG. 5 is a diagram illustrating still another example of determining a tracking error associated with an interest object according to an example embodiment; and

FIGS. 6A through 6C are flowcharts illustrating an example of an object tracking method according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

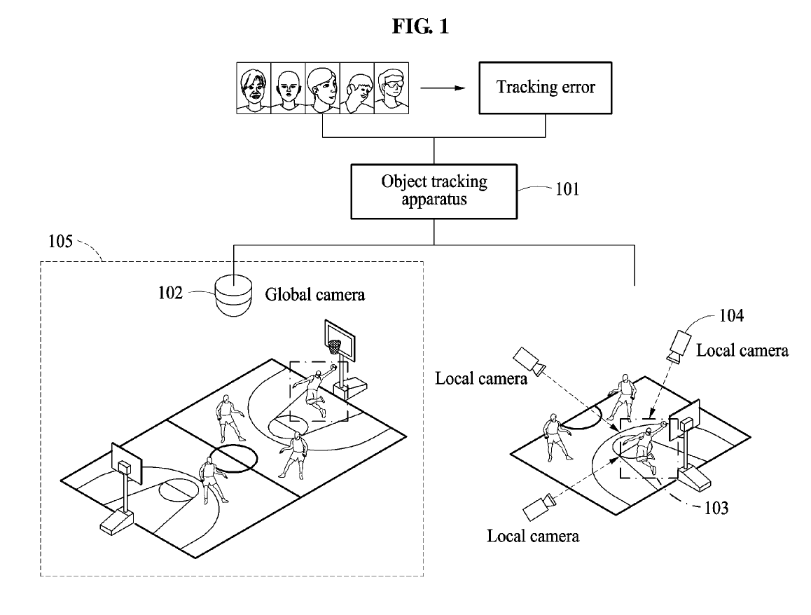

FIG. 1 is a diagram illustrating an example of tracking an interest object, or an object of interest (OOI), according to an example embodiment.

Referring to FIG. 1, an object tracking apparatus 101 may generate a global image by capturing an object search area 105 using a global camera 102. The object tracking apparatus 101 may extract a location of an interest object 103 by tracking the interest object 103 in the global image. Here, the location of the interest object 103 to be extracted may include a central location (x, y) of the interest object 103 included in the object search area 105.

The global camera 102 may be installed in the object search area 105 to capture an entire area of the object search area 105. Here, the global image obtained by the global camera 102 may include a plurality of objects present in the object search area 105. For example, as illustrated in FIG. 1, the global camera 102 may be fixed to a ceiling or a wall of a building including the object search area 105 to capture the entire area of the object search area 105. Here, the object search area 105 may include a height from the ground to a location at which the global camera 102 is installed, and a width of the object search area 105.

The object search area 105 indicates a space to be monitored through the global camera 102 and a local camera 104, and a space in which a plurality of objects moves. The object search area 105 may include, for example, an arena in which a sports game is performed, or a security and surveillance zone.

The object tracking apparatus 101 may capture the interest object 103 using the local camera 104 that is selected based on the location of the interest object 103 extracted from the global image obtained by the global camera 102 to obtain a local image. The object tracking apparatus 101 may identify a location of the interest object 103 by tracking the interest object 103 in the local image obtained by the local camera 104.

Here, the local camera 104 indicates a camera that may track, more intensively, the interest object 103 selected by a user based on the global image collected by the global camera 102. For example, as illustrated in FIG. 1, a plurality of local cameras, as the local camera 104, may be installed at different locations. The object tracking apparatus 101 may capture the interest object 103 by selecting the local camera 104 that is adjacent to the interest object 103 based on the location of the interest object 103 extracted from the global image obtained by the global camera 102.

Dissimilar to the global camera 102 installed on the ceiling or the wall and configured to capture the entire area of the object search area 105, the local camera 104 may capture a portion of the object search area 105 that is adjacent to a location at which the local camera 104 is installed.

The object tracking apparatus 101 may identify the interest object 103 present at a location corresponding to the identified location of the interest object 103. In addition, the object tracking apparatus 101 may generate an identifier (ID) to distinguish the identified interest object 103 from other objects present in the object search area 105. Here, an ID indicates unique information used to identify each of a plurality of objects present in the object search area 105 from another object present in the object search area 105. That is, the ID indicates identification information of a finally identified object using a pre-learned image of an object and a global image.

The object tracking apparatus 101 may determine a tracking error associated with the identified interest object 103, and correct a location of the interest object 103 based on a result of determining the tracking error. That is, the object tracking apparatus 101 may determine the tracking error associated with the interest object 103 by comparing the location of the interest object 103 extracted from the global image and the location of the interest object 103 identified from the local image. For example, the object tracking apparatus 101 may determine the tracking error associated with the interest object 103 by determining an exceptional situation, for example, an occlusion among objects or disappearance from or reappearance in a camera visual field, based on the location of the interest object 103 extracted from the global image and the location of the interest object 103 identified from the local image.

Here, when the tracking error associated with the interest object 103 occurs, the object tracking apparatus 101 may generate a notification signal providing a notification of the tracking error. The object tracking apparatus 101 may correct a location of the interest object 103 at which the tracking error occurs.

The object tracking apparatus 101 may determine the tracking error associated with the interest object 103 and perform correction based on a result of the determining by tracking a location of the interest object 103 in the object search area 105 and identifying the interest object 103 at the tracked location.

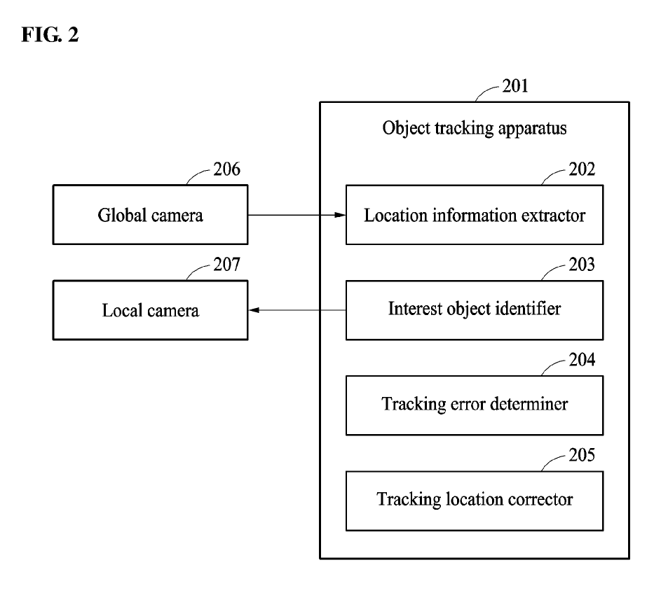

FIG. 2 is a diagram illustrating an example of an object tracking apparatus according to an example embodiment.

Referring to FIG. 2, an object tracking apparatus 201 may identify a location of an interest object in an object search area and the interest object, and determine occurrence of a tracking error associated with the identified interest object, and also may correct the location of the interest object when the tracking error occurs. The object tracking apparatus 201 may include a location information extractor 202, an interest object identifier 203, a tracking error determiner 204, and a tracking location corrector 205.

The location information extractor 202 may generate a global image by capturing an object search area using a global camera 206 configured to capture the object search area, and extract a location of an interest object in the object search area by tracking the interest object included in the global image. Here, the location information extractor 202 may extract a plurality of objects included in the object search area from the global image. The location information extractor 202 may extract respective locations of the extracted objects. The global camera 206 may be installed on a ceiling or a wall in a space including the object search area, and may capture an entire area of the object search area. Here, when a capturing range of the global camera 206 does not include the object search area, the location information extractor 202 may capture the entire area of the object search area by a combination of at least two fixed global cameras.

When the object search area is obtained using the at least two fixed global cameras, the location information extractor 202 may generate the global image of the entire area of the object search area by sharing with one another location values of three points that are not parallel to one another on a plane in an identical observation area. That is, the location information extractor 202 may generate the global image including an entire range of the object search area by applying a homographic method to the location values configured as, for example, a 4×4 matrix with respect to the at least two fixed global cameras.

The location information extractor 202 may transfer, to the tracking error determiner 204, the locations of the objects extracted from the global image to determine a tracking error associated with the interest object. In addition, the location information extractor 202 may transfer, to the interest object identifier 203, the locations of the interest objects extracted from the global image.

The interest object identifier 203 may track a location of the interest object selected by a user from the objects included in the global image, based on the locations of the objects received from the location information extractor 202. The interest object identifier 203 may control a location of a local camera 207 configured to capture a portion of the object search area to track the interest object selected by the user.

Here, the interest object identifier 203 may verify the local camera 207 that is installed adjacent to the location of the interest object selected by the user among the locations of the objects extracted from the global image. The interest object identifier 203 may control a location of the verified local camera 207 to face the location of the interest object. For example, the interest object identifier 203 may control the location of the local camera 207 using a coordinate value of the location of the interest object selected by the user.

Although not illustrated in FIG. 2, the object tracking apparatus 201 may control the location of the local camera 207 based on the location of the interest object extracted from the global image through an additional controller configured to control the local camera 207.

The local camera 207 may obtain a local image by capturing a portion of the object search area at the controlled location based on the coordinate value of the location of the interest object extracted from the global image. Here, the interest object identifier 203 may receive the local image obtained from multiple angles through the local camera 207. That is, the local camera 207 may capture the interest object at multiple angles in cooperation with other local cameras adjacent to the object search area, and transfer the local image obtained from the multiple angles to the interest object identifier 203.

The interest object identifier 203 may identify the interest object by analyzing the local image obtained from the multiple angles through the plurality of local cameras adjacent to the object search area. In addition, the interest object identifier 203 may generate an ID to distinguish the identified interest object from other objects.

The tracking error determiner 204 may determine the tracking error associated with the interest object by analyzing the location of the interest object extracted from the global image and received from the location information extractor 202 and a location of the interest object identified by the interest object identifier 203 from the local image. That is, the tracking error determiner 204 may determine the tracking error associated with the interest object by analyzing a probability of a tracking error described as follows.

(A) A probability of occurrence of a tracking error due to an occlusion among objects a) A probability of a tracking error that may occur due to an occlusion of an interest object by a fixed object in an object search area (Occlusion (A)=True)

b) A probability of a tracking error that may occur due to an overlap between an interest object and a moving object present in an object search area or an occlusion of the interest object by the moving object (Occlusion (B)==True), (Occlusion (C)==True)

(B) A probability of occurrence of a tracking error due to an entry of a new object into an object search area or a movement of an interest object in a screen

a) A probability of a tracking error that may occur due to an entry of a new object into an object search area (Recurrent (D)=True)

b) A probability of a tracking error that may occur due to reappearance of an interest object in an object search area after disappearance from the object search area (Recurrent (D)=True)

Thus, the tracking error determiner 204 may determine a probability of the tracking error associated with the interest object based on a final standard obtained by considering each condition corresponding to each case described in the foregoing. The tracking error determiner 204 may determine a probability of a tracking error due to an occlusion between objects based on a condition represented by Equation 1 below.

If (Occlusion (A)==True) or ((Occlusion (B)==True) and (Occlusion (C)==True)) [Equation 1]

When the condition is satisfied by substituting, in Equation 1, the location of the interest object extracted from the global image and the location of the interest object identified from the local image, the tracking error determiner 204 may determine a high probability of a tracking error due to an occlusion of the interest object by a fixed object or a moving object in the object search area.

Also, the tracking error determiner 204 may determine a probability of a tracking error due to an entry of a new object or reappearance of the interest object based on a condition represented by Equation 2 below.

If (Recurrent (D)==True) [Equation 2]

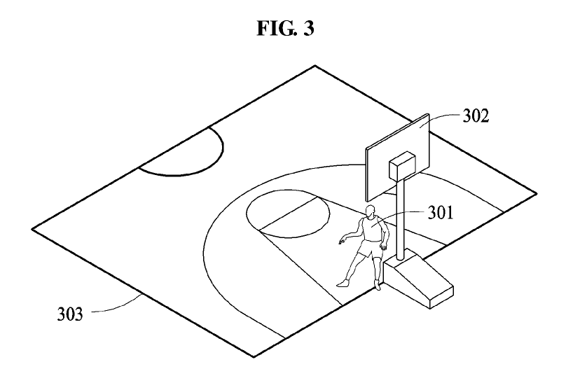

When the condition is satisfied by substituting, in Equation 2, the location of the interest object extracted from the global image and the location of the interest object identified from the local image, the tracking error determiner 204 may determine a high probability of a tracking error due to an entry of a new object or reappearance of the interest object. Hereinafter, an example of determining a tracking error associated with an interest object will be described in more detail with reference to FIGS. 3 through 5.

FIG. 3 is a diagram illustrating an example of determining a tracking error associated with an interest object according to an example embodiment.

Referring to FIG. 3, an object tracking apparatus may determine a tracking error associated with an interest object by analyzing a location of the interest object extracted from a global image and a location of the interest object identified from a local image. As illustrated in FIG. 3, the object tracking apparatus may determine a probability of occurrence of a tracking error associated with an interest object 301 due to an occlusion of the interest object 301 by an object present in an object search area 303.

The object search area 303 is a space in which a plurality of objects is present, and may include an object that moves and an object that is fixed in the object search area 303, for example, a fixed object 302 as illustrated in FIG. 3, based on a characteristic of each object. For example, when the object search area 303 is a basketball arena, a moving object and the interest object 301 may be, for example, a basketball player who plays a basketball game in the basketball arena or a referee, and the fixed object 302 may be, for example, a bench or a basketball hoop stand that is fixed in the basketball arena.

Thus, the object tracking apparatus may predict a situation in which the interest object 301 is occluded by the fixed object 302 fixed in the object search area 303, and determine a tracking error based on the predicted situation. For example, when the interest object 301 stays around the fixed object 302 in the object search area 303 for a while, the object tracking apparatus may predict a situation in which the interest object 301 is occluded by the fixed object 302, and such a predicted situation may be expressed as follows.

Occlusion (A)=True, else Occlusion (A)=False, if a central location of the interest object 301 in the object search area 303 is included in an area of the fixed object 302 in the object search area 303.

In the foregoing, “A” may indicate a condition described after “if.”

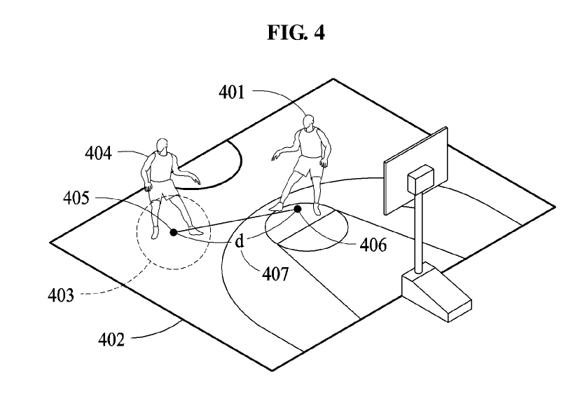

FIG. 4 is a diagram illustrating another example of determining a tracking error associated with an interest object according to an example embodiment.

Referring to FIG. 4, an object tracking apparatus may determine a tracking error associated with an interest object by analyzing a location of the interest object extracted from a global image and a location of the interest object identified from a local image. As illustrated in FIG. 4, the object tracking apparatus may determine a probability of occurrence of a tracking error associated with an interest object 401 due to an occlusion of the interest object 401 by an object present in an object search area 402.

The object search area 402 is a space in which a plurality of objects is present, and may include an object that moves, for example, a moving object 404 as illustrated in FIG. 4, and an object that is fixed in the object search area 402 based on a characteristic of each object. The object tracking apparatus may predict a situation in which the interest object 401 is occluded by at least one object, for example, the moving object 404, and may determine a tracking error based on the predicted situation.

For example, when the interest object 401 overlaps the at least one object, for example, the moving object 404, or occluded by the moving object 404, the object tracking apparatus may predict a situation in which the interest object 401 is occluded by the moving object 404, and the predicted situation may be expressed as follows.

Occlusion (B)=True, else Occlusion (B)=False, if a distance 407 between a central location 406 of the interest object 401 in the object search area 402 and a central location 405 of the moving object 404 having a largest overlapping area with the interest object 401 in the object search area 402 is less than (<) a threshold value, or

Occlusion (C)=True, else Occlusion (C)=False, if a value obtained by dividing a size of an area of the interest object 401 in the object search area 402 by a size of the largest overlapping area of the moving object 404 among other objects overlapping the interest object 401 in the object search area 402 is greater than (>) a threshold value.

In the foregoing, “B” and “C” may indicate each condition described after “if.”

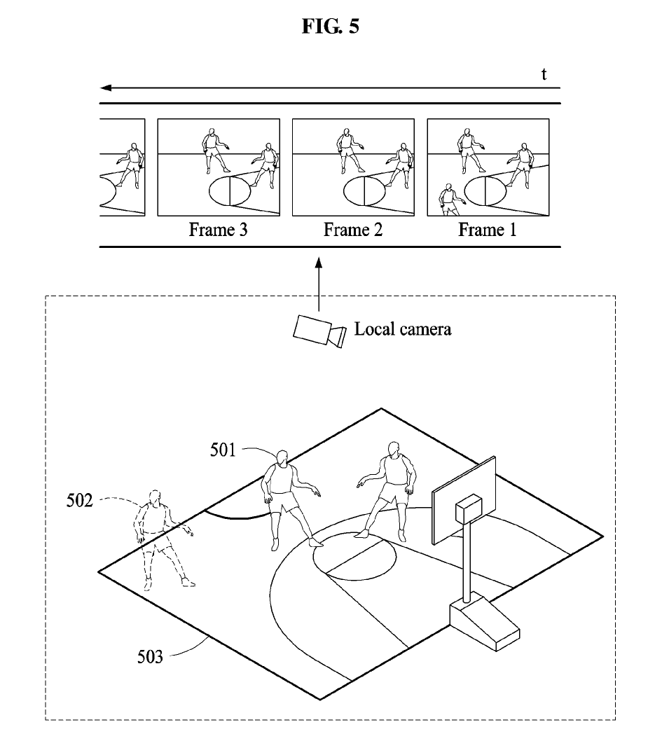

FIG. 5 is a diagram illustrating still another example of determining a tracking error associated with an interest object according to an example embodiment.

Referring to FIG. 5, an object tracking apparatus may determine a tracking error associated with an interest object 501 by analyzing a location of the interest object 501 extracted from a global image and a location of the interest object 501 identified from a local image obtained by a local camera. The object tracking apparatus may determine a probability of a tracking error associated with the interest object 501 that may occur due to an entry of a new object 502 into an object search area 503 or reappearance of the interest object 501.

The object search area 503 is a space in which a plurality of objects is present, and the objects present in the space may not all be fixed, but movable depending on a situation. The object search area 503 may be, for example, a sports arena or a security monitoring area in which a plurality of objects moves or disappears therefrom. Thus, the object tracking apparatus may flexibly respond to such a change in situation to identify locations of the objects in the object search area 503 and the objects.

The object tracking apparatus may predict a situation in which the new object 502 enters the object search area 503 or the interest object 501 reappears after disappearing from the object search area 503, and determine a tracking error based on the predicted situation. Here, the predicted situation may be expressed as follows.

Recurrent (D)=True, else Value (D)=False, if an amount of time during which a central location of the interest object 501 in the object search area 503 is not included in the object search area 503 is greater than (>) a successive frame threshold time, and if an object that is not previously tracked is detected by comparing a current video frame of the object search area 503 to a previous video frame of the object search area 503.

In the foregoing, “D” may indicate a condition described after “if.”

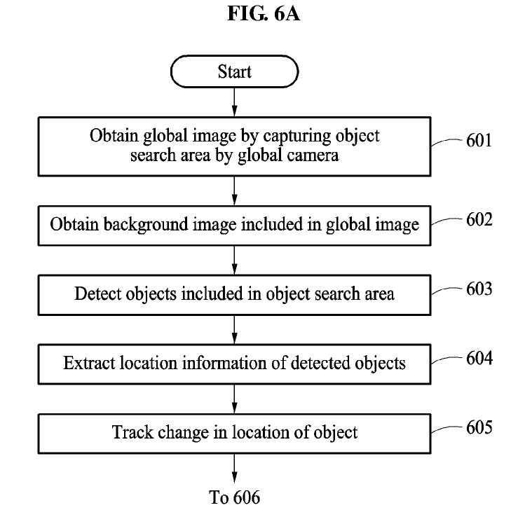

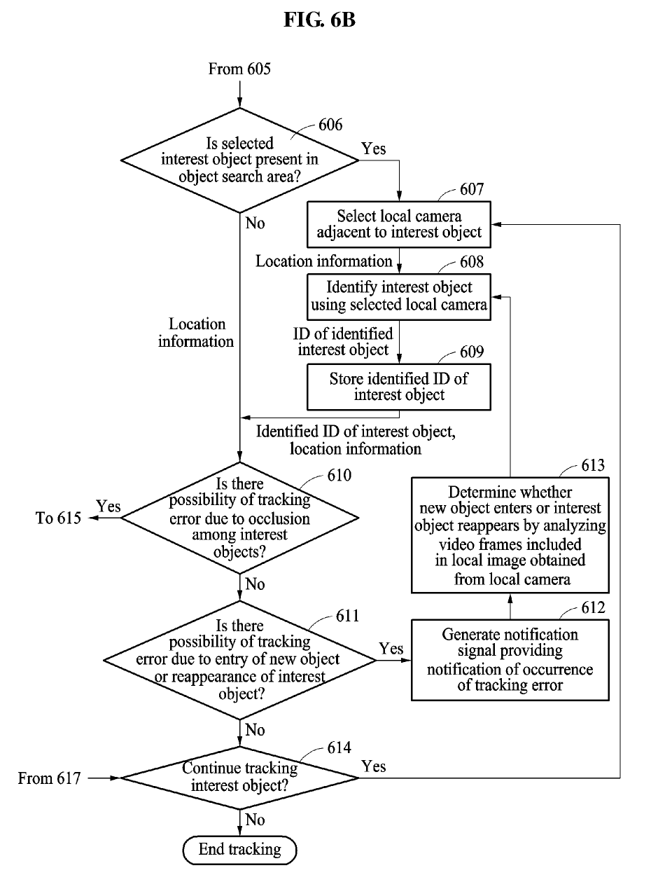

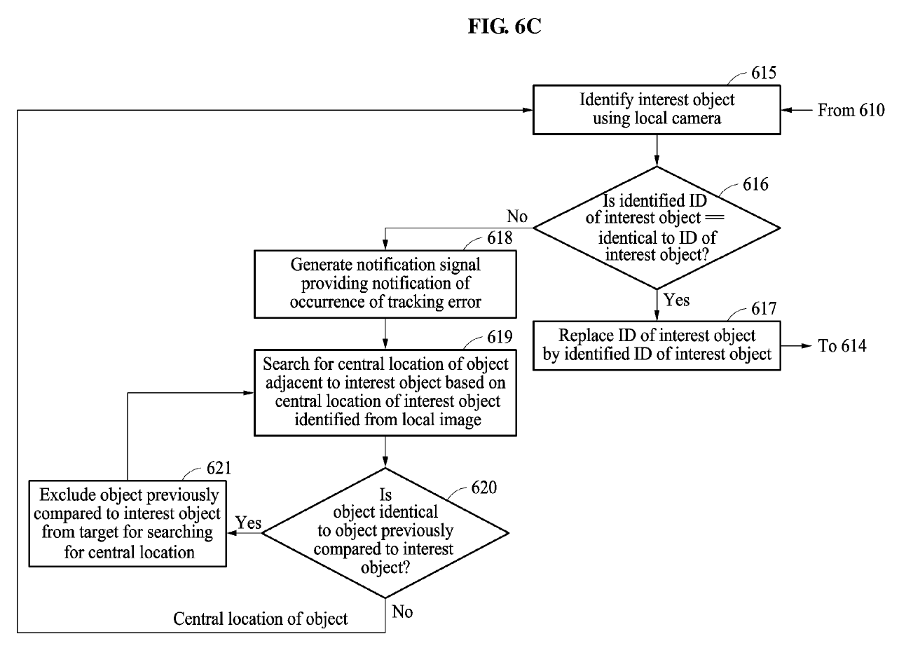

FIGS. 6A through 6C are flowcharts illustrating an example of an object tracking method according to an example embodiment. The object tracking method to be described hereinafter may be performed by an object tracking apparatus.

Referring to FIGS. 6A through 6C, an object tracking method may include an overall processing algorithm of tracking an interest object in an object search area, predicting a situation of a probably tracking error associated with the tracked interest object, and correcting a location of the interest object, based on the description provided with reference to FIGS. 1 through 5.

Referring to FIG. 6A, in operation 601, the object tracking apparatus obtains a global image by capturing an object search area using a global camera.

In operation 602, the object tracking apparatus obtains a background image included in the global image using the global image obtained by the global camera. The obtaining of the background image is to classify the object search area included in the global image.

In operation 603, the object tracking apparatus detects a plurality of objects included in the object search area.

In operation 604, the object tracking apparatus extracts location information associated with the objects detected in the object search area. That is, the object tracking apparatus may extract respective locations of the objects.

In operation 605, the object tracking apparatus tracks a change in the locations of the objects extracted in operation 604 to determine a detailed location of an interest object.

Here, the object tracking apparatus may select the interest object of which a location is to be tracked from among the objects included in the global image obtained by the global camera. Here, a single interest object may be selected by a user as the interest object.

Referring to FIG. 6B, in operation 606, the object tracking apparatus determines whether the interest object selected in operation 605 is included in the object search area. When the interest object is included in the object search area, the object tracking apparatus may perform operation 607. Conversely, when the interest object is not included in the object search area, the object tracking apparatus may perform operation 610.

In operation 607, the object tracking apparatus selects a local camera adjacent to the interest object based on a location of the interest object tracked in operation 605.

In operation 608, the object tracking apparatus identifies the interest object using the local camera selected in operation 607. That is, the object tracking apparatus may track the interest object in a local image obtained by the local camera. In addition, the object tracking apparatus may identify the tracked interest object, and generate an ID of the identified interest object.

In operation 609, the object tracking apparatus stores the ID of the identified interest object.

In operation 610, the object tracking apparatus determines a possibility of a tracking error associated with interest object that may occur due to an occlusion between the objects included in the object search area.

In response to a low probability of a tracking error associated with the interest object due to an occlusion between the objects, the object tracking apparatus may perform operation 611. Conversely, in response to a high probability of the tracking error associated with the interest object due to the occlusion, the object tracking apparatus may perform operation 615.

In operation 611, the object tracking apparatus determines a possibility of a tracking error associated with the interest object that may occur due to an entry of a new object into the object search area or reappearance of the interest object in the object search area. In response to a high probability of a tracking error associated with the interest object due to an entry of a new object into the object search area or reappearance of the interest object in the object search area, the object tracking apparatus may perform operation 612. Conversely, in response to a low probability of the tracking error associated with the interest object due to the entry of the new object and the reappearance of the interest object, the object tracking apparatus may perform operation 614.

In operation 612, the object tracking apparatus generates a notification signal providing a notification of occurrence of the tracking error associated with the interest object.

In operation 613, the object tracking apparatus determines whether the new object enters the object search area or the interest object reappears in the object search area by analyzing video frames included in the local image obtained by the local camera. That is, the object tracking apparatus may determine whether the new object enters or the interest object reappears by comparing a current video frame of the local image to a previous video frame of the local image and detecting an object that is not previously tracked. Subsequently, in operation 608, the object tracking apparatus identifies the new object or the reappearing interest object.

In operation 614, the object tracking apparatus determines whether to continue tracking the interest object.

When the object tracking apparatus determines to continue tracking the interest object, the object tracking apparatus may perform operation 607. Conversely, when the object tracking apparatus determines not to continue tracking the interest object, the object tracking apparatus may terminate the tracking.

Referring to FIG. 6C, in operation 615, the object tracking apparatus identifies the interest object using the local camera.

In operation 616, the object tracking apparatus identifies the interest object by determining whether the ID of the identified interest object is identical to an ID of the interest object. That is, the object tracking apparatus may compare the identified ID of the interest object tracked in the local image obtained by the local camera to an ID of the interest object pre-learned from the global image obtained by the global camera.

When the identified ID is identical to the pre-learned ID, the object tracking apparatus may perform operation 617. Conversely, when the identified ID is not identical to the pre-learned ID, the object tracking apparatus may perform operation 618.

In operation 617, the object tracking apparatus replaces the ID of the interest object by the identified ID of the interest object. After operation 617 is performed, operation 614 may be performed.

In operation 618, the object tracking apparatus generates a notification signal providing a notification of occurrence of the tracking error associated with the interest object. Here, the object tracking apparatus may determine that the interest object identified in operation 615 is not an actual interest object. The object tracking apparatus may set, to be an object previously compared to the interest object, the object that is determined not to be the actual interest object.

In operation 619, the object tracking apparatus searches for a central location of a moving object or a fixed object adjacent to the interest object based on a central location value of the interest object identified from the local image.

In operation 620, the object tracking apparatus determines whether the moving object or the fixed object for which the central location is explored in operation 619 is the object previously compared to the interest object.

When the moving object or the fixed object for which the central location is explored in operation 619 is the object previously compared to the interest object, the object tracking apparatus may perform operation 621.

Conversely, when the moving object or the fixed object for which the central location is explored in operation 619 is not the object previously compared to the interest object, the object tracking apparatus may determine that the moving object or the fixed object is the actual interest object. Here, the object tracking apparatus may perform operation 615 based on the central location explored in operation 619, and re-identify the moving object or the fixed object to be an interest object.

In operation 621, the object tracking apparatus excludes, the interest object and the previously compared object, from a target for which a central location is explored in operation 619.

According to example embodiments, an object tracking method and apparatus may track a location of an interest object and also identify the interest object, and thus may predict, in advance, a tracking error that may occur when a plurality of objects overlaps one another or a disappeared object appears again.

According to example embodiments, an object tracking method and apparatus may track a location of an interest object and also identify the interest object, and thus may predict, in advance, occurrence of a tracking error and correct a location of the interest object based on the tracking error.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, the scope of the present disclosure is defined not by the detailed description, but by the claims and their equivalents, and all variations within the scope of the claims and their equivalents are to be construed as being included in the disclosure.

What is claimed is:

1. An object tracking method comprising:
extracting a location of an interest object from a global image obtained by capturing an object search area including the interest object using a global camera;
capturing the interest object using a local camera adjacent to the location of the interest object;
identifying a location of the interest object from a local image obtained by the local camera; and
determining a tracking error associated with the interest object by analyzing the location of the interest object extracted from the global image and the location of the interest object identified from the local image.

2. The method of claim 1, wherein the extracting of the location of the interest object from the global image comprises:
extracting the location of the interest object from the global image based on a width of the object search area and a height from a ground of the object search area to a location at which the global camera is installed.

3. The method of claim 1, wherein the capturing of the interest object comprises:
capturing the interest object using a plurality of local cameras of which locations for capturing the object search area are controlled based on the location of the interest object extracted from the global image.

4. The method of claim 3, wherein the identifying of the location of the interest object from the local image comprises:
identifying the interest object included in the local image by analyzing the local image obtained by the plurality of local cameras from multiple angles at the controlled locations.

5. The method of claim 1, wherein the determining of the tracking error associated with the interest object comprises:
determining the tracking error associated with the interest object by analyzing a case in which the interest object is located adjacent to a fixed object in the object search area.

6. The method of claim 5, wherein the determining of the tracking error associated with the interest object comprises:
determining the tracking error associated with the interest object by analyzing whether a location of the interest object is included in an area of the fixed object in the object search area.

7. The method of claim 1, wherein the determining of the tracking error associated with the interest object comprises:
determining the tracking error associated with the interest object by analyzing a case in which the interest object is located adjacent to a moving object in the object search area.

8. The method of claim 7, wherein the determining of the tracking error associated with the interest object comprises:
determining the tracking error associated with the interest object based on a distance between a central location of the interest object and a central location of a moving object having a largest overlapping area with the interest object among other objects in the object search area.

9. The method of claim 7, wherein the determining of the tracking error associated with the interest object comprises:
determining the tracking error associated with the interest object based on a size of an area of the interest object occluded by the moving object and a size of an area of the interest object.

10. The method of claim 1, wherein the determining of the tracking error associated with the interest object comprises:
determining the tracking error associated with the interest object by analyzing a new object entering the object search area.

11. An object tracking apparatus comprising:
a location extractor configured to extract a location of an interest object from a global image obtained by capturing an object search area including the interest object using a global camera;
an interest object identifier configured to capture the interest object by a local camera adjacent to the location of the interest object, and identify a location of the interest object from a local image obtained by the local camera;
a tracking error determiner configured to determine a tracking error associated with the interest object by comparing the location of the interest object extracted from the global image and the location of the interest object identified from the local image; and
a tracking location corrector configured to correct a tracking location of the interest object based on a result of determining the tracking error.

12. The apparatus of claim 11, wherein the tracking error determiner is configured to determine the tracking error associated with the interest object by analyzing a case in which the interest object is located adjacent to a fixed object in the object search area.

13. The apparatus of claim 12, wherein the tracking error determiner is configured to determine the tracking error associated with the interest object by analyzing whether a location of the interest object is included in an area of the fixed object in the object search area.

14. The apparatus of claim 11, wherein the tracking error determiner is configured to determine the tracking error associated with the interest object by analyzing a case in which the interest object is located adjacent to a moving object in the object search area.

15. The apparatus of claim 14, wherein the tracking error determiner is configured to determine the tracking error associated with the interest object based on a distance between a central location of the interest object and a central location of a moving object having a largest overlapping area with the interest object among other objects in the object search area.

16. The apparatus of claim 14, wherein the tracking error determiner is configured to determine the tracking error associated with the interest object based on a size of an area of the interest object occluded by the moving object and a size of an area of the interest object.

17. The apparatus of claim 11, wherein the tracking error determiner is configured to determine the tracking error associated with the interest object by analyzing a new object entering the object search area.
